(19) United States
(12) Patent Application Publication
(10) Pub. No.: US 2026/0085954 A1
(43) Pub. Date: Mar. 26, 2026

(54) MEASURING SYSTEM FOR PROCESS AUTOMATION

(71) Applicant: VEGA Grieshaber KG, Wolfach (DE)

(72) Inventor: Timo Seckinger, Aichhalden (DE)

(73) Assignee: VEGA Grieshaber KG, Wolfach (DE)

(21) Appl. No.: 19/337,052

(22) Filed: Sep. 23, 2025

(30) Foreign Application Priority Data
Sep. 23, 2024 (DE) 102024127415.8

(51) Int. Cl. G01D 21/02

(52) U.S. Cl. CPC G01D 21/02

(57) ABSTRACT

A measuring system for process automation in an industrial or private environment, with a first field device for capturing first process measurement data and a computing arrangement for evaluating the captured first process measurement data, the computing arrangement determining a new installation position and/or new parameterization of the first field device on the basis of the evaluation of the captured first process measurement data in order to improve the measurement result.

### CROSS-REFERENCE TO RELATED APPLICATIONS

This application claims the benefit of the filing date of German Patent Application No. 102024127415.8 filed on 23 Sep. 2024, the entire content of which is incorporated herein by reference.

### FIELD

The present disclosure relates to process measurement technology. In particular, the present disclosure relates to a measurement system for process automation in industrial or private environments, a method for operating a measurement system in industrial or private environments, a program element, a computer-readable medium, and training data for training an algorithm based on machine learning and/or artificial intelligence for use by a measurement system in industrial or private environments.

### TECHNICAL BACKGROUND

In process automation in industrial or private environments, field devices are used, such as level measuring devices, pressure measuring devices, or flow measuring devices. The level measuring devices can be, for example, radar level measuring devices, which determine the level using free-beam or guided microwave signals.

It has been shown that the installation and parameterization of field devices may sometimes have a major influence on the quality of the measurement results. In order to maximize the quality of the measurement results, a high level of expertise is sometimes required.

### SUMMARY

There may be a need to increase the quality of the measurement results of a field device in industrial and private environments.

This need is addressed by the features of the independent patent claims. Further details of the present disclosure are provided in the subclaims and the following description of embodiments.

A first aspect of the present disclosure relates to a measurement system for process automation in industrial and private environments. The measurement system has a first field device that is configured to capture first process measurement data.

The first process measurement data is, for example, level measurement data or pressure measurement data. However, the technical teaching of the present disclosure is also applicable to other process measurement data, so that the scope of protection covers not only level and pressure measuring devices, but also other measuring devices in which the installation location and/or parameterization can have a direct influence on the quality of the measurement result.

The measuring system also has a computing arrangement, such as a computing circuitry, that is configured to evaluate the captured first process measurement data. Parts or even the entire computing arrangement can be integrated into the first field device. However, it will often also be the case that one of the computing arrangements is integrated into other, neighboring field devices and/or into the cloud or an external control unit.

The computing arrangement is configured to determine a new installation position and/or new parameterization of the first field device based on the evaluation of the captured first process measurement data in order to improve the measurement result.

The computing arrangement is configured to recognize from the captured first process measurement data that the installation position and/or the parameterization of the first field device can be changed in order to improve the measurement result of the first field device. For example, it is possible that the computing arrangement knows what an optimal measurement result should look like based on its knowledge of the measurement environment. By analyzing the captured process measurement data, it can determine what changes need to be made to the installation position and/or the parameterization of the first field device in order to improve its measurement result accordingly.

In particular, it may be possible that the computing arrangement also receives or has access to process measurement data from other field devices. In a simple case, it can thus determine which field device has the best installation position and/or parameterization by comparing the measuring devices of the various field devices and then suggest this to the user for the other field devices.

The computing arrangement may also be configured to independently re-parameterize a corresponding field device in order to improve the measurement result.

According to one embodiment of the present disclosure, the new installation position of the first field device is a new installation location of the first field device, for example in a tank or silo.

According to a further embodiment of the present disclosure, the first field device in the new installation position has a different installation angle than in the previous installation position in which the first process measurement data was recorded. This installation angle can be, for example, a rotation angle around the longitudinal axis of the field device. If the field device is screwed into a container opening, it can, for example, be rotated by 90 degrees. However, the installation angle can also be related to the radiation angle of the measurement signal, so that the field device is tilted in the new installation position relative to the old installation position and thus has a different radiation direction.

According to a further embodiment of the present disclosure, the new parameterization of the first field device includes a new linearization of the first field device. The term "linearization" is known in the present technical field and essentially corresponds to a calibration of the field device.

However, the parameterization may also involve a so-called min-max adjustment, i.e., a redefinition of the range in which the field device is to measure. In the case of a level measuring device, this refers to the lowest and highest fill levels.

Another embodiment of the present disclosure relates to the measuring system described above, which further comprises a second field device that is configured to capture second process measurement data. The computing arrangement is also configured to evaluate the captured second process measurement data. It is also configured to determine a new installation position and/or new parameterization of the first field device based on the evaluation of the captured first and second process measurement data in order to further improve the measurement result.

In addition to the first field device and the second field device, further field devices may be provided, all of which can communicate with the computing arrangement in order to transmit their corresponding process measurement data to it.

According to a further embodiment of the present disclosure, the new installation position is different from the installation position of the first field device and the second field device. However, it may also be the case that the new installation position of the first field device corresponds to the installation position of the second field device.

According to a further embodiment of the present disclosure, the new parameterization is different from the parameterization of the first field device and the parameterization of the second field device. However, it may also be provided that the new parameterization (of the first field device) corresponds to the parameterization of the second field device.

According to a further embodiment of the present disclosure, the first field device and the second field device are identical in construction or at least similar in construction. In the case of level measuring devices, this will mean that the containers/silos in which the first and second field devices are installed are also identical in construction or at least similar. However, this may not be absolutely necessary.

According to a further embodiment of the present disclosure, the computing arrangement comprises a cloud and/or an external control unit.

According to a further embodiment of the present disclosure, the first field device and/or the second field device (and/or possible further field devices) is a level radar, for example an open-beam level radar or a level radar that uses guided signals to measure the level, or a pressure measuring device, in particular a differential pressure measuring device.

According to a further embodiment of the present disclosure, the captured first process measurement data and/or the captured second process measurement data are echo measurement data from which echo curves can be calculated.

According to a further embodiment of the present disclosure, the computing arrangement is configured to determine the new installation position and/or the new parameterization of the first field device and/or the second field device using an algorithm based on machine learning and/or artificial intelligence.

According to a further embodiment of the present disclosure, the algorithm based on machine learning and/or artificial intelligence is a pre-trained algorithm stored on a data storage device of the field device.

According to a further embodiment of the present disclosure, the computing arrangement is configured to train the algorithm based on machine learning and/or artificial intelligence during operation of the field device.

A second aspect of the present disclosure relates to a method for operating a measuring system in an industrial or private environment, for example a measuring system as described above. The method comprises the following steps: capturing first process measurement data; evaluating the acquired, captured first process measurement data; and determining a new installation position and/or a new parameterization of a first field device based on the evaluation of the acquired first process measurement data in order to improve the measurement result of the first field device.

According to a further embodiment of the present disclosure, the method further comprises using and/or training an algorithm based on machine learning and/or artificial intelligence to evaluate the captured first process measurement data and/or to determine the new installation position and/or the new parameterization of the first field device.

It should be noted at this point that when it is mentioned above or below that the first process measurement data is evaluated or otherwise processed/analyzed, this can also be done with the corresponding process measurement data from the other field devices if further field devices are provided. In principle, the measurement result is more likely to be improved if the process measurement data from as many field devices as possible is collected, analyzed, and processed.

Another aspect of the present disclosure relates to a program element which, when executed on a computing arrangement of a measurement system described above or below, causes the measurement system to perform the method described above and below.

Another aspect of the present disclosure relates to a computer-readable medium on which the program element described above is stored.

Another aspect of the present disclosure relates to training data for training an algorithm based on machine learning and/or artificial intelligence for use by a measurement system in an industrial or private environment, for example, a measuring system described above and below, wherein the training data is based on the captured first process measurement data, for training the algorithm based on machine learning and/or artificial intelligence to determine the new installation position and/or the new parameterization of the first field device.

The computer program product and the training data may comprise any of the features or steps mentioned herein that are described in relation to the first aspect of the present disclosure, i.e., the field device, or the second aspect of the present disclosure, i.e., the method, or that may apply analogously thereto.

For example, the training data may be training data generated at least in part during operation of the field device. Alternatively or additionally, the training data may be training data generated at least in part outside the measurement system in which it is used, for example, training data generated in a plurality of measurement systems in the same or different applications. The training data may also include input data that detects and/or characterizes the deviation, wherein the input data is based, for example, on a manual evaluation of the cause of the measurability of the measurement result during maintenance of a field device. For example, the input data may also or alternatively include instructions to be used by the algorithm for learning. The input data may, for example, originate from a technician.

The term "process automation in an industrial environment" can be understood as a subfield of technology that includes measures for operating machines and systems without human intervention. One goal of process automation is to automate the interaction of individual components of a plant in the chemical, food, pharmaceutical, petroleum, paper, cement, shipping, or mining industries. A variety of sensors can be used for this purpose, which are specially adapted to the specific requirements of the process industry, such as mechanical stability, insensitivity to contamination, extreme temperatures, and extreme pressures. The measured values from these sensors are usually transmitted to a control room, where process parameters such as fill level, limit level, flow, pressure, or density can be monitored and settings for the entire plant can be changed manually or automatically.

One sub-area of process automation in the industrial environment concerns the logistics automation of plants and the logistics automation of supply chains. With the help of distance and angle sensors, processes within or outside a building or within a single logistics facility are automated in the field of logistics automation. Typical applications include logistics automation systems for baggage and cargo handling at airports, traffic monitoring (toll systems), retail, parcel distribution, and building security (access control). What the examples listed above have in common is that presence detection in combination with accurate measurement of the size and position of an object is required by the respective application. For this purpose, sensors based on optical measurement methods using lasers, LEDs, 2D cameras, or 3D cameras that detect distances using the time-of-flight (ToF) principle can be used.

Another subfield of process automation in the industrial environment concerns factory/production automation. Applications for this can be found in a wide variety of industries, such as automotive manufacturing, food production, the pharmaceutical industry, or in the packaging sector in general. The aim of factory automation is to automate the manufacture of goods using machines, production lines, and/or robots, i.e., without human intervention. The sensors used and the specific requirements in terms of measurement accuracy when detecting the position and size of an object are comparable to those in the previous example of logistics automation.

The terms used in the claims should be interpreted in such a way that they are given the broadest possible reasonable interpretation in accordance with the above description. For example, the use of the article "a" or "the" when introducing an element should not be interpreted as excluding a plurality of elements. Similarly, the mention of "or" should be interpreted as including a plurality of elements, so that the mention of "A or B" does not exclude "A and B" unless it is clear from the context or the preceding description that only one of A and B is meant. Furthermore, the phrase "at least one of A, B, and C" should be understood as one or more elements from a group of elements consisting of A, B, and C, and should not be interpreted as requiring at least one of each of the listed elements A, B, and C, regardless of whether A, B, and C are connected as categories or in any other way. In addition, the mention of "A, B, and/or C" or "at least one of A, B, or C" should be interpreted as including each individual unit of the listed elements, e.g., A, each subset of the listed elements, e.g., A and B, or the entire list of elements A, B, and C.

Further embodiments of the present disclosure are described below with reference to the figures. The illustrations in the figures are schematic and may not be to scale. Where the same reference numerals are used in the following figure description, they refer to the same or similar elements.

### BRIEF DESCRIPTION OF THE FIGURES

FIG. 1 shows a measuring system according to an embodiment of the present disclosure.

FIG. 2 shows a flowchart of a method according to an embodiment of the present disclosure.

FIG. 3 shows a further representation of a measuring system according to an embodiment of the present disclosure.

FIGS. 4A, 4B, and 4C show echo curves of the field devices shown in FIG. 3.

### DETAILED DESCRIPTION OF EMBODIMENTS

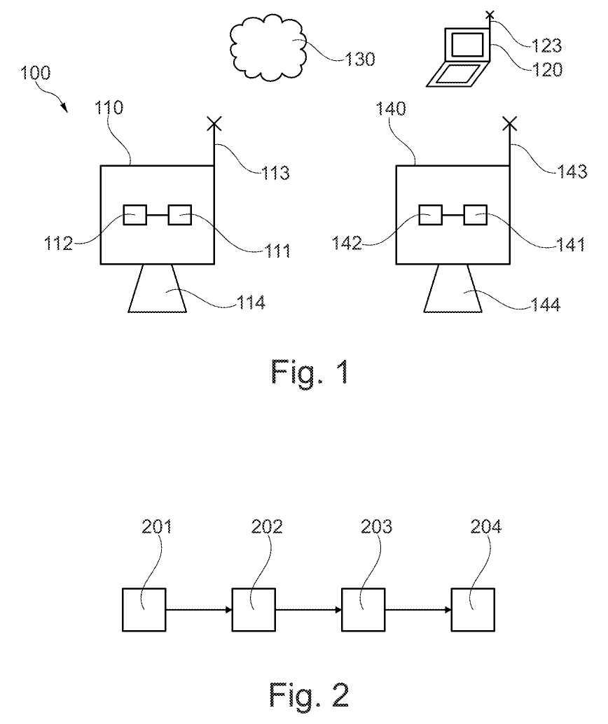

FIG. 1 shows a measuring system 100 for process automation in industrial or private environments. The measuring system 100 has two (or more) field devices 110, 140, each of which is configured to capture process measurement data, such as fill levels. However, these may also be pressure measuring devices, flow meters, or other measuring devices.

Each of the field devices 110, 140 has a computing arrangement 111, 141 that is connected to a data memory 112, 142. However, the elements described above only partially form the computing arrangement. The remaining components of the computing arrangement include an external control unit 120 and a cloud 130. These various elements are connected to each other for communication, for example via a wireless communication link via the antennas 113, 143, 123 and/or (not shown) a wired communication link.

The field devices shown in FIG. 1 are level radar devices with corresponding antennas 114, 144, via which the radar measurement signals are transmitted and received again.

FIG. 2 shows a flowchart of a method according to an embodiment of the present disclosure. In step 201, first process measurement data is acquired by a first field device and second process measurement data is acquired by a second field device. In step 202, the first and second process measurement data are evaluated and sometimes compared with each other. In step 203, it is determined, based on the evaluation of the captured first and second process measurement data, that a new installation position and/or new parameterization of the first field device and/or the second field device can lead to an improvement in its measurement result. In step 204, the new installation position and/or the new parameterization data are communicated to the user.

At this point, it should be noted that the method is a computer-implemented method which, at least in some or all embodiments, does not require human intervention but can be performed fully automatically by the measuring system.

In an upstream step, the captured process measurement data can also be used to train an algorithm based on machine learning and/or artificial intelligence to evaluate the captured first/second process measurement data and/or to determine the new installation positions and/or the new parameter settings of the first/second field device.

The method thus determines the best mounting position on identical or similar silos/tanks from one or more sensor data sets from one or more field devices (e.g., echo curves) and informs the user/plant operator about the optimal sensor position in order to achieve a better/more stable measurement result.

In this way, the application process can be optimized and stabilized to prevent possible failures and malfunctions in the process.

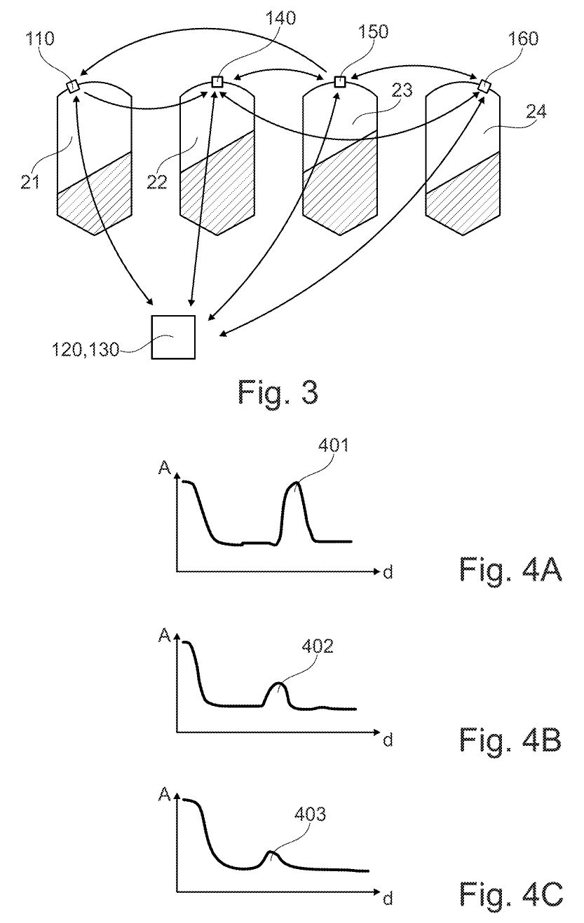

FIG. 3 shows a specific application with four bulk material silos 21, 22, 23, 24, in each of whose ceiling areas a field device in the form of a level measuring device 110, 140, 150, 160 is installed. The installation positions differ from each other. Only devices 140 and 150 are located in the same position.

All field devices can communicate with each other and exchange process measurement data or information derived from it. They can also communicate with an external control device or a cloud 120, 130 and transfer their process measurement data or data derived from it to it. The cloud/external control device collects the data from the various field devices, analyzes it, compares it, and derives the best installation positions/parameter settings, which are then transmitted to the corresponding field device or a user on site. For example, it may be specified that the installation position is displayed on the corresponding field device. At the same time, the user can be informed, for example, by the field device emitting a light signal or by receiving a message on their mobile device. The control unit/cloud can be configured to import the new parameterization directly into the field device, so that user interaction is not necessary.

It may also be provided that the computing arrangement informs the user of a new installation position for a specific field device, even if it is not yet clear whether this will lead to an improvement in the measurement result. This may be the case, for example, if the user has installed all field devices in the corresponding silo/tank at the same location, so that all measurement results are basically similar when the silos are filled to the same height. Nevertheless, in this case, the computing arrangement may determine that the measurement results are not yet optimal and encourage the user to install individual field devices in a different location. Similarly, in this case, the computing arrangement may independently change the parameterization of one or more of the field devices in order to attempt to improve the respective measurement result.

This makes it possible to identify the optimal mounting position in a digitally networked system of sensors in identical or very similar tanks or silos or other measuring points, such as sewer manholes, either directly or with the aid of a higher-level unit, such as a control unit 120 or a cloud 130, using networked field devices/sensors. sewer manholes, using the sensors located in the digitally networked system.

The sensors and/or the higher-level systems, such as the control unit or the cloud system, are networked either via cable and/or a radio connection. The devices jointly analyze the information obtained from the individual sensors, such as the echo curves of the radar sensors and their configurations/parameterizations.

Once sufficient data has been collected and analyzed from the individual sensors, the measuring system makes a recommendation to the plant operator/user as to which of the at least two positions at the respective measuring point is the better one in order to ensure permanently safe operation without measurement errors.

If both mechanical mounting positions are identical, the set parameters of the sensors can still be adjusted/compared and optimized or synchronized between the individual sensors in order to improve the measurements as a whole.

This improvement option is also suggested to the plant operator/user.

The optimization suggestion itself can be communicated to the user either via the sensor display, a display on the higher-level system, or directly in the cloud system.

It is also important that the intelligence is not only located in the cloud/control system/control unit, but that the sensors can also perform simple analyses among themselves with regard to the better mounting position/setting and pass on the results.

The main application is predictive maintenance/optimization. At this point, it should be noted that the correct mounting position, i.e., the mechanical alignment of the sensor to the measuring point, e.g., to the tank/silo/sewer shaft, accounts for approximately 90% of the measurement reliability. This means that a poor mounting position can only be compensated for to a limited extent or not at all by reconfiguring the sensor.

FIGS. 4A to 4C show three example echo curves for the three different mounting positions of field devices 110, 140, 150, and 160 shown in FIG. 3.

FIG. 4A shows a pronounced peak 401, which is caused in the echo curve by the reflection on the bulk material surface. This echo curve was captured by field device 110 in silo 21, which appears to be in a very good mounting position.

FIG. 4B shows an echo curve as recorded, for example, by field devices 140 or 150. These two field devices are in a slightly poorer mounting position, as can be seen from the lower amplitude 402 of the bulk material echo compared to FIG. 4A.

FIG. 4C shows the echo curve 403 detected by field device 160, which is almost lost in the noise because this field device is in an unfavorable mounting position due to the sloping bulk material surface.

In this case, the computing system will select the position of sensor 110, as the echo curve of this sensor shows the best reflection of the medium compared to the other two possible mechanical mounting positions. The measurement system therefore recommends that all sensors be mechanically moved to the position of sensor 110 in order to achieve the best possible measurement performance.

1. A measurement system for process automation in an industrial or private environment, comprising:
a first field device configured to capture first process measurement data; and
computing circuitry configured to evaluate the captured first process measurement data,
wherein the computing circuitry is further configured to determine a new installation position and/or a new parameterization of the first field device on a basis of evaluation of the captured first process measurement data in order to improve a measurement result.

2. The measurement system according to claim 1,
wherein the new installation position of the first field device is a new installation location of the first field device.

3. The measurement system according to claim 1,
wherein the first field device has an installation angle in the new installation position which is different to an installation angle in the installation position of the first field device.

4. The measurement system according to claim 1,
wherein the new parameterization of the first field device includes a new linearization of the first field device.

5. The measurement system according to claim 1, further comprising:
a second field device configured to capture second process measurement data,
wherein the computing arrangement is configured to evaluate the detected second process measurement data, and
wherein the computing arrangement is configured to determine a new installation position and/or a new parameterization of the first field device based on the evaluation of the captured first and second process measurement data in order to improve the measurement result.

6. The measurement system according to claim 1,
wherein the new installation position is different from the installation position of the first field device and from the installation position of the second field device.

7. The measurement system according to claim 1,
wherein the new parameterization is different from the parameterization of the first field device and from the parameterization of the second field device.

8. The measurement system according to claim 5,
wherein the first field device and the second field device are identical or similar in construction.

9. The measurement system according to claim 1,
wherein the computing arrangement includes a cloud and/or an external control circuit.

10. The measurement system according to claim 1,
wherein the first field device and/or the second field device is a level radar.

11. The measurement system according to claim 1,
wherein the captured first process measurement data and/or the captured second process measurement data are echo measurement data from which echo curves are calculatable.

12. The measurement system according to claim 1,
wherein the computing circuitry is further configured to determine the new installation position and/or the new parameterization of the first field device and/or the second field device using an algorithm based on machine learning and/or artificial intelligence.

13. The measurement system according to claim 12,
wherein the algorithm based on machine learning and/or artificial intelligence is a pre-trained algorithm stored on a data storage device of the field device.

14. The measurement system according to claim 12,
wherein the computing circuitry is further configured to train the algorithm based on machine learning and/or artificial intelligence during operation of the field device.

15. A method for operating a measuring system in an industrial or private environment, comprising:
capturing first process measurement data;
evaluating the captured first process measurement data; and
determining, based on an evaluation of the captured first process measurement data, a new installation position, and/or new parameterization of a first field device in order to improve a measurement result of the first field device.

16. The method according to claim 15, further comprising:
applying and/or training an algorithm based on machine learning and/or artificial intelligence to evaluate the captured first process measurement data and/or to determine the new installation position and/or the new parameterization of the first field device.

17. A non-transitory computer readable medium having stored thereon a program element that, when executed by computing circuitry of a measurement system, causes the computing circuitry to be configured to
capture first process measurement data;
evaluate the captured first process measurement data; and
determine, based on an evaluation of the captured first process measurement data, a new installation position, and/or new parameterization of a first field device in order to improve a measurement result of the first field device.

18. Training data for training an algorithm based on machine learning and/or artificial intelligence for use by the measuring system according to claim 1,
wherein the training data is based on the captured first process measurement data for training the algorithm based on machine learning and/or artificial intelligence for determining the new installation position and/or the new parameterization of the first field device.

19. The measurement system according to claim 1,
wherein the first field device and/or the second field device is a freely radiating or guided level radar.

20. The measurement system according to claim 1,
wherein the first field device and/or the second field device is a differential pressure measuring device.
